(19) United States
(12) Patent Application Publication
(10) Pub. No.: US 2006/0272724 A1
(43) Pub. Date: Dec. 7, 2006

(54) System and method for pipe repair using fiber wrap and polymeric resin

(76) Inventors: Robin Neil Borland, Smethport, PA (US); Henry E. Topf JR., Wellsboro, PA (US); Brian L. Rice, Perkiomenville, PA (US)

Correspondence Address: FISH & RICHARDSON P.C., P.O. BOX 1022, MINNEAPOLIS, MN, 55440-1022, US

(21) Appl. No.: 11/410,606

(22) Filed: Apr. 25, 2006

Related U.S. Application Data
(60) Provisional application No. 60/675,007, filed on Apr. 26, 2005.

(51) Int. Cl. F16L 55/16

(52) U.S. Cl. 138/99; 138/172

(57) ABSTRACT

A system and method of repairing a pipe including securing a reinforcing material, such as a dry fiber structure (e.g., carbon fibers) to the surface of the pipe. An outer sleeve is installed around the reinforcing material. A polymeric material is placed (e.g., poured) into the interior of the sleeve around the reinforcing material. External pressure is applied to the sleeve. The polymeric material substantially saturates the reinforcing material and cures to form a reinforced polymeric composite which may increase or restore the pressure rating or operating pressure capacity of the pipe.

### CLAIM OF PRIORITY

This application claims priority on U.S. Provisional Application Ser. No. 60/675,007, filed Apr. 26, 2005, the disclosure of which is incorporated by reference.

### TECHNICAL FIELD

The invention relates generally to pipe repair. More particularly, the invention relates to techniques for repairing a pipe with fiber-reinforced polymeric material.

### BACKGROUND

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Piping is omnipresent in today's society. Piping is found in a wide range of residential, commercial, and industrial applications. For example, piping may be employed in utility distribution, manufacturing processes, chemical/petrochemical transport, energy transmission, plumbing, heating and cooling, sewage systems, as well as in the recovery of spent chemicals/compounds, such as discharges of exhausted chemicals, contaminated water, and so forth. In operation, piping within facilities and over longer distances may serve to collect, distribute, and transport water, steam, chemicals, petrochemicals, crude oil, natural gas, and a variety of other liquids, gases, and components.

Pipe failures and damage may be caused by mechanical harm, corrosion, erosion, damaged coatings, failing insulation, adverse operating conditions, weather, and so on. Internal erosion, for example, may occur due to the flow of the contents through the pipeline. Such erosion may be exacerbated by centrifugal forces associated with changes in the direction of the flow path. In regard to corrosion, the external surface of piping may be exposed to corrosive soil or above-ground corrosive environments, and the internal surface of piping may be exposed to corrosive contents. Significantly, erosion, corrosion, and other damage may reduce the wall thickness of the pipe and thus reduce the pressure rating or pressure-holding capacity of the pipe or pipeline.

Defects such as corrosion, mill defects, third party damage (e.g. dents, scratches, gouges), stress corrosion cracking and hydrogen induced cracking have the potential to cause catastrophic failure in pipelines that are in operation or under testing.

Various internal and external inspection methods for pipelines are well known in the art. When a defect has been identified, one of several prior art methods of repair may be selected based on the location of the pipeline, the type of defect and size of defect. David Boreman, Bradley Wimmer and Keith Leewis have published a paper on selection of repair methods titled “Repair Technologies for Gas Transmission Pipelines” in the PIPELINE & GAS JOURNAL in March 2000. The subject article is incorporated herein by reference. Additionally, a discussion of known prior art repair equipment and systems is compiled in a paper prepared by AEA Technology Consulting for the Health and Safety Executive Division for Offshore Technology Report 2001/038, the disclosure of which is incorporated by reference herein. In evaluating repair decisions, pipeline operators and service providers typically consider the pipeline downtime, pipe specifications, the pipe area to be repaired, buried conditions, the above-ground environment, the contents of the piping or pipeline, pipeline operating conditions, and the like. Of course, the pipeline operators and service providers should accommodate regulatory constraints, appropriate industry standards, manufacturer recommendations, and so on. Moreover, the maintenance approach ultimately selected may involve repair of a leak or other failure, or the preemptive repair of a pipe area prior to failure (e.g., leak, rupture, etc.) of the pipeline. Finally, in an effort to maintain pipeline integrity while being mindful of costs, the environment, regulatory constraints, and so on, the pipeline operators and service providers typically assess the maintenance, replacement, and repair of piping/pipelines based on available engineering alternatives and the economic impact of those alternatives. In the case of a repair, several technologies, application techniques, and materials are available.

Common repair technologies employ metal sleeves that are disposed about a section of a pipe to reinforce the pipe. Both welded sleeves and non-welded (mechanical) sleeves may be installed over varying lengths and diameters of piping to repair pipe leaks and other failures. Also, sleeves may preemptively repair potential pipe failures, reinforce pipe areas of internal and external corrosion, upgrade the pressure rating of the piping, and so forth. In general, established sleeve techniques, whether utilizing sleeves welded in place around the pipe, or employing sleeves mechanically secured to the pipe without welding, offer the advantage of being familiar repair approaches in the industry. In the repair of pipelines, operators, engineers, and craftsmen are accustomed to working with welded fittings for welded sleeves, as well as with mechanical devices and clamps for non-welded sleeves. Unfortunately, the training of personnel in the suitable mechanical and welding techniques is expensive for proper installation of the sleeves. Further, non-welded and welded sleeve repair of pipelines may result in embrittlement and residual stresses at the point of repair on the pipeline.

For welded sleeves, the sleeves may be welded around the pipe to be repaired, encasing the pipe segment to be reinforced. The mating edges of the sleeve halves may be welded to each other, and the ends of the erected sleeve welded to the pipe, to seal and secure the welded sleeve to the pipe. It should be emphasized that a variety of welding configurations other than the generic approach described above may be employed in installing the welded sleeve. Costs associated with welding repairs, including welded-sleeve repairs (e.g., on high-pressure transmission pipelines), may be attributed to the use of highly-skilled welders, the shutdown and deinventory of the pipeline, and the shutdown of associated manufacturing facilities, chemical/petrochemical processes, and so on.

Generally, it is desirable from an operating cost standpoint to repair piping while the pipeline remains in service, thus eliminating costly downtime. Repair techniques that avoid welding or cutting of the pipe, for example, may make it feasible to maintain the pipeline in service during the repair and thus avoid the costs associated with pipeline downtime. It should be emphasized that a shutdown of a pipeline for repair can potentially force the shutdown of upstream and downstream facilities, resulting in lost production, lost sales, shutdown and startup costs, and so forth.

Non-welded sleeves address this concern, because they generally do not require welding or cutting. Non-welded reinforcement sleeves are mechanically coupled to the pipe section to be repaired. In other words, these non-welded sleeves (also called mechanical sleeves) may be positioned and secured to the pipe by clamps, bolts, and so on.

Repair with non-welded sleeves may advantageously avoid welding at the on-site repair, such as in pipeline areas and in chemical/petrochemical process areas, for example. Further, as indicated, non-welding approaches generally permit uninterrupted operation of the pipeline. On the other hand, in certain configurations for non-welded (mechanical) sleeves, the pipeline may be deinventoried if significant mechanical force is to be applied to the pipe or because of other factors during installation of the non-welded sleeve.

Unfortunately, the special case of repair of piping elbows, piping tees, pipeline bends, and so on, is problematic for both welded and mechanical (non-welded) sleeves due to the difficultly of placing a rigid metal sleeve around the curved pipe bend to be repaired. Further, the rigid metal sleeves may be unable to make adequate contact at the pipeline bends, and thus be unable to reinforce the stressed points that typically exist at the pipeline bends. Furthermore, it may be difficult to appropriately match the radius of curvatures of the outer metal sleeve and the pipeline elbow or bend. To avoid these problems with installing sleeves at pipeline bends, a weld filler metal (in lieu of a sleeve) may be deposited on the bend (e.g., in a cavity of an anomaly) but such welded filler repairs are generally appropriate only for limited ranges of pipeline operating pressures and wall thicknesses.

As can be seen from the discussion in the paragraphs above, a variety of challenges exist with welded and non-welded (mechanical) sleeves. On the whole, these established techniques of using reinforcement sleeves, whether welded or non-welded, tend to be costly, require highly skilled labor, result in increased pipe stresses, and increase the need to interrupt pipeline service. A need exists for improved techniques of pipe repair.

In response to the problems and challenges associated with the conventional approaches of welded and non-welded sleeves in the repair of both straight pipe and pipe bends, new technologies have emerged that involve coatings and the use of high-strength plastics, fiber-reinforced plastics, composite materials, and the like. Such polymeric repairs may reduce costs and provide for less embrittlement and residual stresses than traditional welded and mechanical sleeves. Furthermore, polymeric composites, for example, generally do not oxidize and, consequently, may arrest further external corrosion of the treated area of the pipeline. Moreover, as a result of the growing use of composite repair systems, particularly in the oil and gas transportation industry, the American Society of Mechanical Engineers (ASME) is currently in the process of setting standards for non-metallic wrap technology including development of a new post-construction repair standard. Currently, a draft of the new ASME standard specifies that several material properties of the repair system are to be measured and evaluated.

It should be noted that resin alone (without reinforcing materials) typically does not provide adequate strength for pipe repair, especially in the repair of medium and high pressure pipelines. Accordingly, in general, polymer repair systems are based on a matrix composite fabric with epoxy materials and other resins, creating a monolithic structure around the damaged pipe. In general, a variety of fibers, polymers, resins, pre-polymers, adhesives, and other components may be used to form a composite material structure around the damaged portion of the pipe. In particular, composite repair systems typically employ glass fibers and offer the potential to reduce repair costs of corroded pipes by avoiding costly mechanical sleeves, welding, and downtime.

As discussed below, however, fabrication of these composite repairs tends to be labor intensive. For example, each layer of the fiber is wetted with dripping resin prior to wrapping the fiber around the pipe. Several layers of fiber and resin (also referred to herein as polymer) are methodically applied by hand one layer at a time, with the fibers slowly and carefully pre-wetted in resin prior to the application of each fiber layer. For example, the fiber (e.g., fiber tape) may be pulled through a bath of polymer (e.g., epoxy resin) as the fiber is cumbersomely applied to the pipe. Such tedious handling and open installations pose environmental, worker safety and application challenges, including increased handling and worker exposure to potentially toxic resins, chemicals and solvents, increased labor time, and the like.

In addition, as appreciated by those of ordinary skill in the art, the worker should be aware of the resin pot life (i.e., resin set-up time in minutes or hours) where the viscosity of the resin significantly increases as the pot life expires, making it difficult to properly apply the resin to the fiber, and to effectively mold and form the polymer resin composite. The resin pot life should not be confused with the resin cure time which is the time for the resin to form a cross-linked thermoset, typically occurring a day or several days later. The pot life (and associated increase in viscosity) of such resin systems may typically only comprise a few minutes. Undoubtedly, an installation not completed prior to expiration of the resin pot life could result in a flawed composite structure surrounding the pipe and pipe anomaly.

In general, a tension exists between the technique of slow and cumbersome pre-wetting and application of the fiber, layer-by-layer, versus the relatively hasty formation of the viscous resin structure due to expiration of the resin pot life and associated increase in viscosity. Thus, in pipe composite repair, many fiber and resin systems are difficult to mold and shape into the appropriate composite structure that overlay the pipe and pipe anomaly.

The details of one or more embodiments of the invention are set forth in the accompanying drawings and the description below. Other features, objects and advantages of the invention will be apparent from the description and drawing, and from the claims.

### SUMMARY

The present invention includes a method of reinforcing a portion of pipe having a defect. The reinforcing steps include: applying a fiber structure to a portion of pipe to be reinforced; installing a sleeve enclosing the portion of pipe to be reinforced and at least a portion of the fiber structure; disposing a polymeric material between the sleeve and the fiber structure enclosed in the containment element to substantially saturate the fiber structure; and permitting the polymeric material to cure to form a composite of the fiber structure and the polymeric material on the surface of the portion of pipe to be reinforced. The method may be used with not only pipe, but Y's, elbows, Tees, crosses and nozzles.

The method further includes wrapping the fiber structure around an outer surface of the pipe section to be reinforced. The fiber may be spirally wrapped with partially overlapping layers around the outer surface of the pipe section to be repaired. The fiber structure is not impregnated with polymeric material prior to or while applying the fiber structure to the object.

The sleeve element may comprise a fabric sleeve, and the polymeric material may be poured inside the sleeve through at least one opening disposed on the sleeve. The fabric sleeve may include a fabric funnel connected to at least one opening disposed on the sleeve. When the present invention includes a funnel attached to the sleeve, the method of practicing the invention may include the steps of: (a) closing the top of the funnel; (b) attaching a bar to the upper portion of the funnel; (c) twisting the bar to reduce the volume of the funnel and exert pressure on the resin contained in the funnel and fabric sleeve thereby forcing the resin to penetrate at least a portion of the fabric wrapped around the portion of the pipe with the defect.

In another embodiment of the invention, an injection port is disposed on the sleeve and the port may be connected to a source of pressurized polymeric material. The polymeric material may be injected under pressure through the injection port into the container element. Additionally, a temporary opening serving as an evacuation port may be disposed on the sleeve.

The liquid resin is allowed to cure to form a reinforced polymeric composite.

The invention is also a system for repairing a pipe, comprising: a dry fiber fabric configured to wrap around the pipe and to receive a resin after installation of the dry fiber on the pipe; a sleeve configured to encase a portion of the pipe having the dry fiber fabric; and a fluid resin formulated to be poured inside the container to penetrate the dry fiber fabric and to form a composite with the penetrated dry fiber fabric on the portion of the pipe.

The sleeve may include sealing elements configured to substantially seal the sleeve with the pipe and dry fiber, wherein a cavity is formed between the sleeve and pipe to receive the fluid resin.

The fluid resin comprises an epoxy system. Preferably the pot life of the fluid resin is in the range of 30 minutes to 90 minutes.

The details of one or more embodiments of the invention are set forth in the accompanying drawings and the description below. Other features, objects, and advantages of the invention will be apparent from the description and drawings, and from the claims.

### DESCRIPTION OF DRAWINGS

The disclosed invention will be described with reference to the accompanying drawings, which show important sample embodiments of the invention and which are incorporated in the specification. A more complete understanding of the invention may be had by reference to the following detailed description when taken in conjunction with the accompanying drawings, wherein:

FIG. 1 is a block diagram of an exemplary method of repairing a pipe in accordance with an exemplary embodiment of the present invention;

FIG. 2 is a perspective view of a pipe with an external defect;

FIG. 3 is a perspective view of the pipe with a defect of FIG. 2 wherein the defect is being filled with dimensional restoration material;

FIG. 4 a perspective view of the pipe of FIG. 3 wherein the filler material in the pipeline defect is being trimmed to match the outside diameter of the pipe;

FIG. 5 is an perspective view of a pipe repair sleeve of the present invention being positioned proximal to the defect to be repaired in order to measure where the fiber wrap and seal areas should be located on the pipe;

FIG. 5A is a side cross-section view of a middle portion of the pipe repair sleeve of FIG. 5.

FIG. 5B is a side cross-section of an end seal portion of the pipe repair sleeve of FIG. 5;

FIG. 6 is a perspective view of the pipe of FIG. 2 that has a primer being applied to the surface of the pipe before the fiber wrap of FIG. 7 is applied;

FIG. 7 is a perspective view of a fiber wrap being applied in a spiral manner on the pipe of FIG. 6;

FIG. 8 is a perspective view of the fiber wrap after it has been applied in accordance to FIG. 7 and secured over the defect of FIG. 2;

FIG. 9 is a perspective view of the pipe sleeve of the present invention partially installed over the fiber wrap of FIG. 8;

FIG. 10 is a perspective view of the pipe sleeve of the present invention installed on the pipe of FIG. 2 prior to filling the sleeve with resin;

FIG. 11 is a perspective view illustrating applying straps and tightening straps at the distal ends of the pipe sleeve to secure and seal the pipe sleeve to the pipe of FIG. 2 to be repaired;

FIG. 12 is a perspective view illustrating an upper portion of an integral funnel of the pipe sleeve that is turned down in preparation of pouring resin into the pipe sleeve;

FIG. 13 is a perspective illustrating resin being poured into the pipe sleeve via the integral funnel of FIG. 12;

FIG. 14 is a perspective illustrating the upper end of the integral funnel of FIG. 12 turned up and having a bar inserted in the upper section of the funnel for exerting pressure on the resin contained in the integral funnel and sleeve of FIG. 12; and

FIG. 15 is a perspective cross-sectional end view of a section of pipe repaired having a composite system repair in accordance with one implementation of the present invention.

Like reference symbols in the various drawings indicate like elements.

### DETAILED DESCRIPTION

One or more exemplary implementations of the present invention will be described below. Like reference numerals in the various figures refer to like parts.

For ease of discussion the steps and items used in the composite repair system of this invention will refer to repair and/or strengthening of a pipe but it will be understood that the items and methods discussed herein may be used to strengthen and/or repair pipelines, pipe fittings, vessel nozzles, vessels, machines, tanks, pumps, valve bodies, and other items as well. Pipe being repaired may be part of a pipeline (e.g., a gas or liquid transmission pipeline) and may be constructed of a variety of metallic and/or non-metallic materials, such as cement, plastics, and so on. Exemplary pipe metals may include steel, carbon steel, stainless steel, copper, brass, and more exotic metals such as nickel alloys and other metal alloys, and the like. Exemplary pipe polymeric materials include polypropylene, polyethylene, other thermoplastics, thermosets, filler-reinforced polymers, fiberglass-reinforced plastic, and so on. The pipe may also include internal and external coatings (not illustrated) to arrest corrosion, inhibit exposure to sunlight, protect against chemical attack, and so forth.

To reinforce or repair the pipe the present techniques provide for a substantially self-forming composite of dry fiber structure (“wrap”) and polymeric material (“resin”) on the outer surface of the pipe. As discussed in detail below, properties of the dry fiber structure and resin may be specified such that hand or wet lay-up is not required because the resin penetrates around the fibers within the dry fiber structure to the outer surface of the pipe. Thus, the resin may be applied on top of the fiber structure without having to pre-wet the fibers or layers of the fiber structure. Again, the cumbersome handling of wet dripping fiber may be advantageously avoided.

The present techniques provide for efficient pipe repair or strengthening by forming a reinforced polymeric composite on the pipe while avoiding the typical extensive handling of the repair materials associated with composite repair.

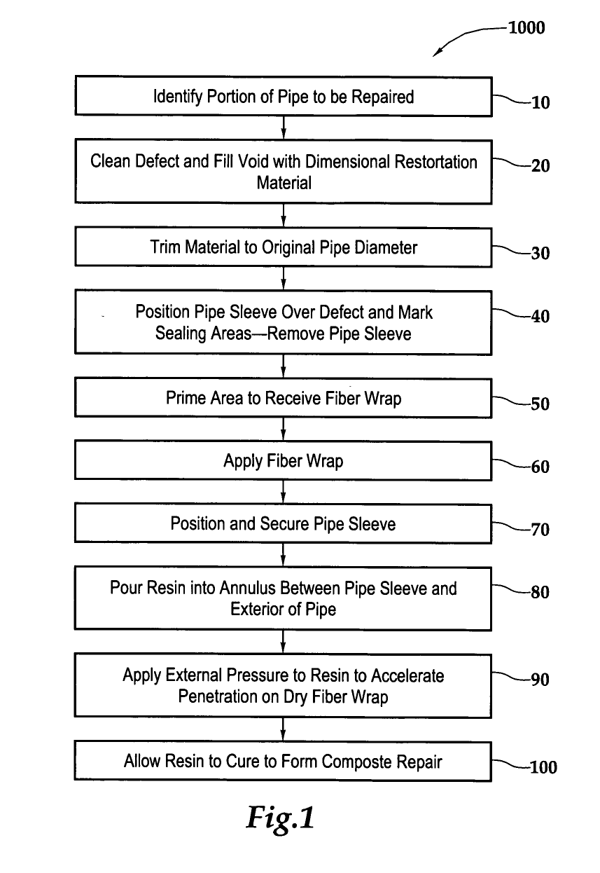

Turning to the drawings, FIGS. 1-14 depict an exemplary implementation of a pipe repair system 1000 which may be used to repair a defect in a pipe and/or reinforce a pipe, increase the wall thickness of a pipe, restore or increase the pressure rating or pressure capacity of a pipe, repair a pipe fitting such as a Wye, Tee, cross, elbow or nozzle on a vessel or a vessel. Referring in particular to FIG. 1, therein is a block diagram of a method 1000 for repairing a pipe, and will be referred to in the discussion of the exemplary techniques depicted in FIGS. 2-14. Referring to FIGS. 1 and 2, initially at step 10, an anomaly 110 (also referred to herein as a “defect”) may be detected on the inner or outer surface of the pipe 101, and thus the portion of the pipe to be repaired is identified, as indicated in block 10.

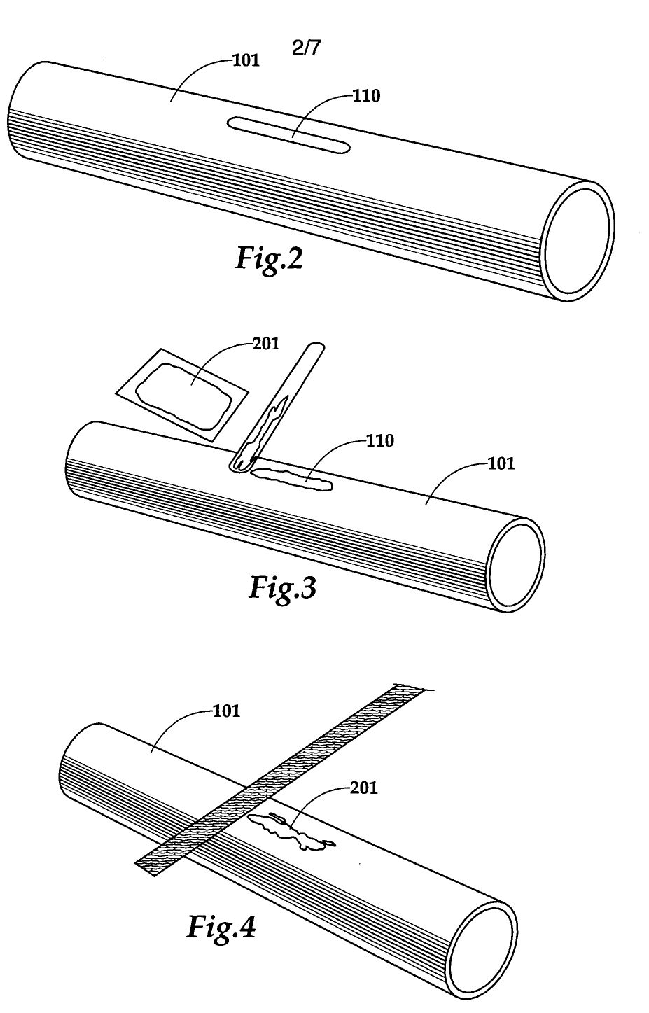

Upon identification and analysis of the anomaly (and prior to application of a reinforcing material such as a dry fiber structure), the anomaly may be pre-treated at step 20 (FIG. 3) in some manner, such as by cleaning the anomaly, grinding or sanding the anomaly 110, placing dimensional restoration material 201 in the defect.

At step 30 (FIG. 4) the filler material 201 is trimmed using a file, grinder, knife or in other known manners. It is desirable to conform the outer surface of the filler material in the defect to the outer surface of the pipe or other item being repaired in order to provide a smooth contiguous surface on which to apply the fiber wrap 601 of Step 60. Conforming the filler material 201 to the outside profile of the pipe repaired or strengthened reduces the possibility of a stress concentration on the area of the defect remaining after the defect is repaired. If the defect is not pre-filled to the correct dimensions, when the fiber wrap 601 is applied there may be a void between the inner surface of the fiber wrap and the exterior surface of the filler material 201 that will not allow the fiber wrap 601 to provide the desired structural support to the defect area 110 being repaired.

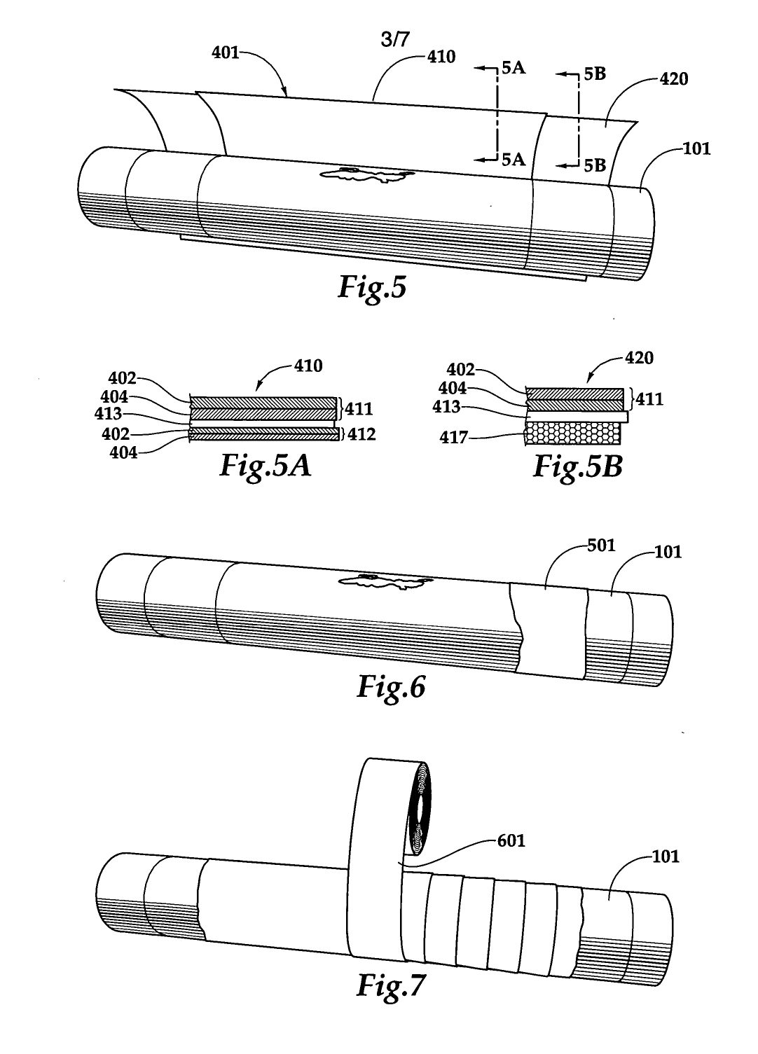

At step 40 (FIG. 5) the pipe sleeve is positioned in proximity to the defect 110 to be repaired. The pre-fabricated sleeve 401 may be available in predetermined sizes corresponding to standard OD sizes of pipe and other items to be repaired/strengthened using the composite repair system of this invention. The pipe sleeve 401 may be formed from Kevlar, fiberglass, polymer sheets, woven fabrics, thin metal or a composite layered structure. The repair sleeve 401 is placed in proximity to the defect and the area where the sleeve will be secured to the pipe 101 is determined.

Pipe Repair 401 sleeve may consist of multiple layers (FIG. 5A). In one implementation a mid-section 410 of the sleeve may have a composite first layer 411 of rip stop nylon 402 having a urethane internal coating 404. The rip stop nylon 402 is disposed to the outer side of the sleeve. A layer of strengthening/stiffening material such as cotton ducking 413 may be used as an intermediate layer. A second layer 412 of composite rip stop nylon 402 with a urethane coating 412 is disposed adjacent the cotton ducking 413 with the urethane coated side positioned adjacent to the outer surface of the pipe 101 to be repaired.

The pipe repair sleeve 401 may consist of additional layers (FIG. 5B). In one implementation an end section of the sleeve may have a composite first layer 411 of rip stop nylon 402 having a urethane internal coating 404 as a first layer. The rip stop nylon 402 is disposed to the outer side of the sleeve. A layer of strengthening/stiffening material such as cotton ducking 413 is used as an intermediate layer. A second layer of closed cell foam 417 may be disposed adjacent the cotton ducking and adjacent to the outer surface of the pipe 101 to be repaired. It will be understood that other unitary or multiple layer combinations of materials may be used to form the pipe sleeve of the present invention.

In alternative implementations, the pipe sleeve may be adapted to allow for adding one or more panels to lengthen the sleeve in the longitudinal direction (X-X) of the pipeline. Lengthening the sleeve by attaching several panels together to form sleeve 401 allows a large section of pipe 101 to be repaired. The additional panels may be attached using hook and loop fasteners (VELCRO®), zippers, zip lock connections, buttons, snaps and other types of fasteners.

Referring again to FIG. 1, step 50 includes applying a primer 501 to the pipe 101 before wrapping with fiber wrap 601. FIG. 6 is a perspective view of the pipe 101 illustrating primer 501 being applied to the surface of the pipe before the fiber wrap 601 is applied. The primer 501 is preferably a cross-linked resin that will enhance the bond between the fiber wrapping 601 and the outer surface of the pipe. Additionally, the primer serves as a barrier to corrosion of the external surface of the item being strengthened or repaired. As understood by those skilled in the art, when a pipe coating is not bonded properly to the surface of a pipe (or other item) corrosion can occur between the surface and the coating. Additionally, the primer coating 501 serves as an adhesive to hold the fiber wrap in place while it is being wrapped around the section of pipe 101.

Referring again to FIG. 1, after the pipe section being repaired or strengthened is primed in step 50, a dry fiber wrap 601 is applied in step 60. It should be understood that the dry fiber wrap 601 may be applied in any number of configurations. In some implementations a patch may be applied. In other implementations a single piece of fiber wrap may be wrapped longitudinally around a pipe or in other instances a tape of fiber wrap 601 may be spirally wound around the pipe. FIG. 7 is a perspective view of a fiber wrap 601 being applied in a spiral manner on the pipe 101. In some embodiments the spiral wrapping of a tape of dry fiber 601 is done in a manner such that 75% of each succeeding wrap overlays the prior wrap (except for the end wraps) thereby ending up with four (4) layers of wrap in the area to be repaired or reinforced. It is desirable for the wrapping to extend on either side of the defect.

In an alternative embodiment, fiber wrap 601 may be applied in a single sheet on the pipe 101. As discussed above regarding the spiral wrapping procedure, it is desirable that the sheet is of sufficient size to allow wrapping at least four (4) times around the exterior surface of the pipe 101. In other implementations, more or less than four (4) layers of wraps may be used in either the spiral or sheet wound implementations. The number of layers of fiber wrap 601 is a function of the size of pipe and the desired operating pressure of the pipe. The fiber wrap may carry a portion of the hoop stress of the pipe wall.

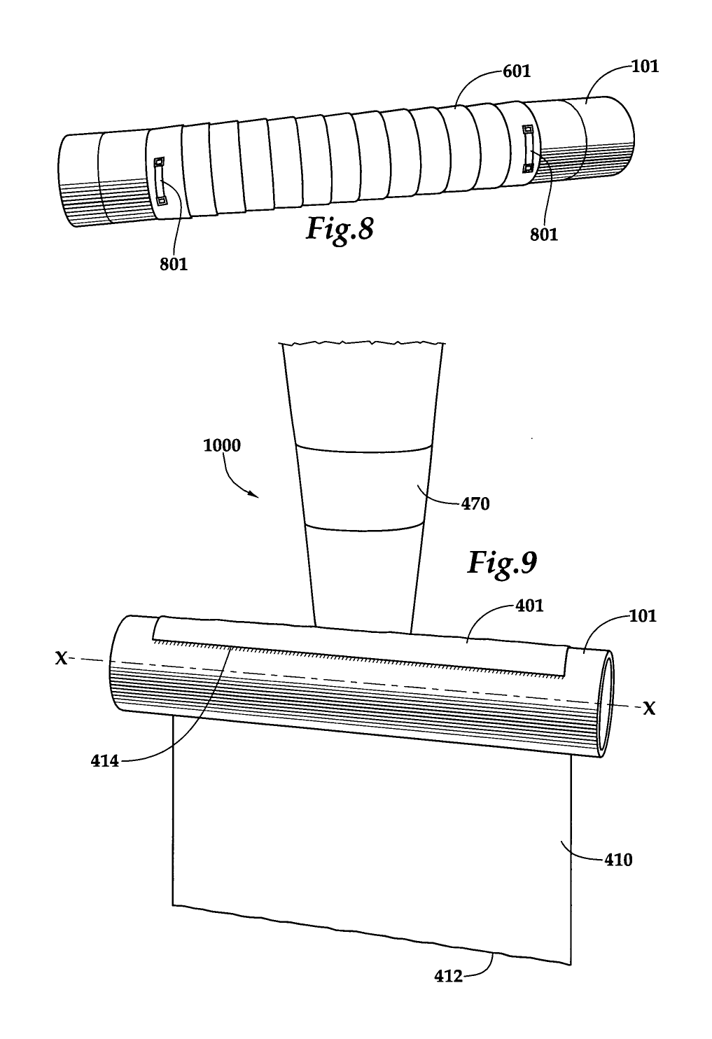

FIG. 8 is a perspective view of the fiber wrap 601 after it has been applied in and secured with a connector 801. The connector may be a belt or a grip type connector that guides the fiber wrap over the defect 110.

Variables to consider in the selection of the dry fiber wrap 601 include a fiber having a strength sufficient to carry a portion of the hoop stress of the pipe and restore, maintain or increase the desired pressure rating of the pipe. In pipe composite repair, the tensile properties of the repair beneficial to restoration of the 100% MAOP are typically primarily promoted by the reinforcing fiber element of the system, such as the exemplary dry fiber structure 601 depicted in FIG. 8. The dry fiber structure 601 may be constructed of a variety of materials, such as glass, advanced polymers, carbon, organic materials such as Kevlar, inorganic materials such as ceramic, polyester, polyacrylics, polypropylene, Nylon (polyamide fibers), and other materials. In general, the dry fiber structure 601, such as a fiber mat or tape, may be configured to receive a polymeric material such as a resin 801 to form a reinforced composite. For example, the dry fiber structure 601 may have a weave structure to facilitate formation of a matrix or composite when the polymeric material/resin 801 is applied to the dry fiber structure 601.

Many types of fibers, such as glass fibers, carbon fibers, and others may be utilized in the present techniques. Particularly beneficial fibers (i.e., for stiffness, strength and application properties) are carbon fibers. Many forms of carbon fiber may be used. An exemplary form of useful carbon fiber is woven tape. An advantageous tape construction may be unidirectional carbon (warp) with some other non-structural or less structural fiber (glass or polyester) in the weft direction. Further, it should be noted that fiber tapes and other fiber structures can be manufactured with a number of constructions. For example, in certain embodiments, the fibers of the dry fiber structure 601 may be unidirectional or omni-directional.

Further, the number of wraps or layers of the dry fiber structure 601 around the damaged pipe 101 may depend on the desired pressure rating or desired maximum allowable operating pressure of the repaired piping system. Engineering properties of the dry fiber structure 601 which may be considered include the ultimate tensile strength and modulus in the longitudinal and transverse directions of the dry fiber structure 601 (and ultimately the repaired pipe 101).

After the fiber wrap 601 is applied and secured in step 60, the pipe sleeve 401 is positioned over the fiber wrap 601 and is secured in place in step 70. FIG. 9 is a perspective view of the pipe sleeve 401 of the present invention partially installed over the fiber wrap 601. The pipeline sleeve may be formed from Kevlar, fiberglass, polymer sheets, woven fabric, thin metal or composite layered structures. In one implementation, the pipe sleeve 401 may include a panel 410 having opposing longitudinal edges 412 and 414. The panel 410 is placed around the pipe section to be repaired such that the opposing longitudinal edges 412 and 414 are brought together and are parallel to a longitudinal axis X-X of the pipe section 101 to be repaired (FIG. 9) to form a substantially sealable cavity between the inner surface of the pipe sleeve 401 and the outer surface of the pipe 101 and fiber wrap 601.

Various methods may be used to join longitudinal edges to one another. Selection of a particular method may depend on cost of the joining system, time needed for the joining step, and strength of the joint. In one implementation a mastic panel may be disposed on one of the longitudinal edges. A paper facing may be peeled off the mastic and then the opposing longitudinal edges joined to form a cylinder surrounding the pipe section to be repaired. Alternatively, other methods using zippers, zip lock type fasteners, hook and loop fasteners (VELCRO®), buttons or other known fastening systems may be used to secure the opposing longitudinal ends 412 and 414 to one another to form the pipe sleeve 401. Moreover, the fastener may be integral to or part of the sleeve, and not an independent component. It should be emphasized that a variety of fastening elements, such as welded elements, glue, adhesives, staples, flanges, bolts, screws, and other components, may be used to secure the longitudinal edges of the sleeve and to provide for effective sealing of the resin within the cavity formed between the inner surface of the sleeve and the outer surface of the pipe.

It is important to understand that one of the distinguishing features of the pipeline sleeve 401 of this pipeline repair system 1000 is that the sleeve is not meant to carry any significant portion of the structural load of the pipeline (hoop stress or longitudinal stress).

Other repair systems having a sleeve have used polymeric resin in an annulus between the inside surface of the sleeve and the outside surface of the pipeline to transfer a substantial portion of the stress load of the pipeline to the containment component. See pending application Ser. No. 10/952,657, filed Sep. 29, 2004 by the co-inventors of this application for discussion of external sleeves designed to carry the load of the pipeline.

In the present system 1000 the pipe sleeve containment component 401 is meant to hold the polymeric resin 801 while it is impregnating the fiber wrap 601 and to receive an imposed external pressure sufficient to accelerate the polymeric resin 801 in impregnating the wrapped reinforcing structure contained inside of the containment component and around the pipe section 101 being repaired.

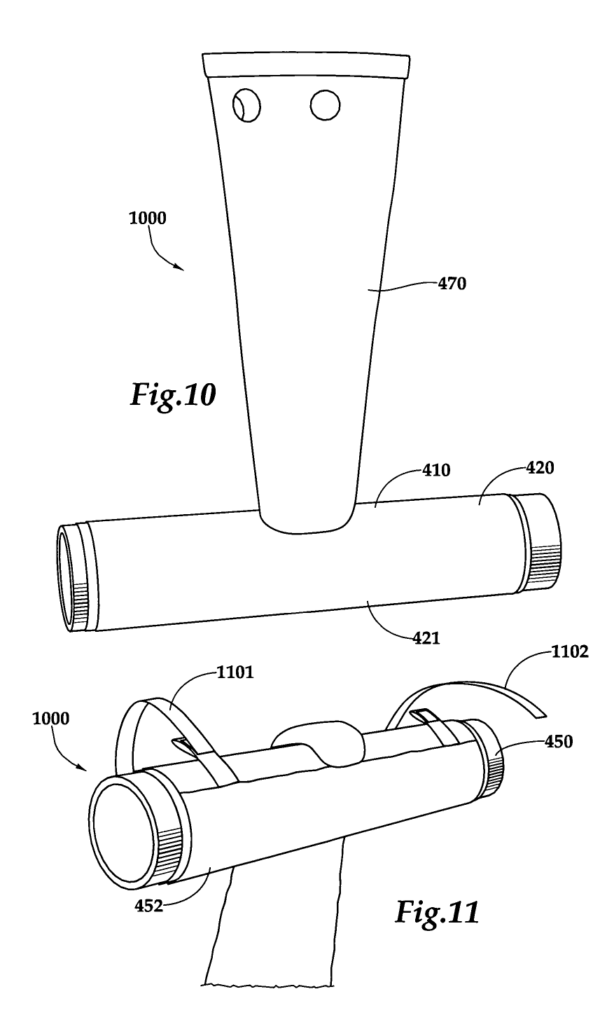

FIG. 10 is a perspective view of the pipe sleeve 401 of the present invention installed on the pipe 101 prior to filling the sleeve 401 with resin 801. FIG. 11 is a perspective view illustrating applying straps/bands 1101 and 1102 and tightening straps/bands 1101 and 1102 at the distal ends of the pipe sleeve to secure and seal the pipe sleeve 401 to the pipe 101. Straps 1101 and 1102 are disposed above the end section 420 of pipe sleeve 410 (FIGS. 5, and 5B). As discussed heretofore regarding FIG. 5B, a closed cell foam layer 417 is on the inner surface of the end portion pipe sleeve 420. The closed cell foam is below the tightening bands 1101 and 1102. As the bands are tightened by known methods, the closed cell foam 417 is compressed and forms a radial seal at the longitudinal ends 450 and 452 of the pipe sleeve 401. Bands 1101 and 1102 may be any type of strap/band used to secure items together, e.g. polymeric cable ties, or a simple hose clamp.

It will be understood that other sealing means may be used instead of bands 1101, 1102 and closed cell foam 417 in the implementation of the present invention and are included in the scope of the present invention. Such sealing means may include rubber strips, and/or expandable mechanical end seals as known in the pipeline art. Any seal that accomplishes formation of a substantially sealable cavity between the section of pipe 101 that includes the dry fiber structure 601 and the inner surface of the pipe sleeve 401 may be used. Moreover, the sealing element may be integral to or part of the sleeve, and not an independent component. It should be emphasized that welded elements, glue, adhesives, staples, flanges, bolts, screws, and other components, may be used to secure the sleeve in the pipe repair system 1000.

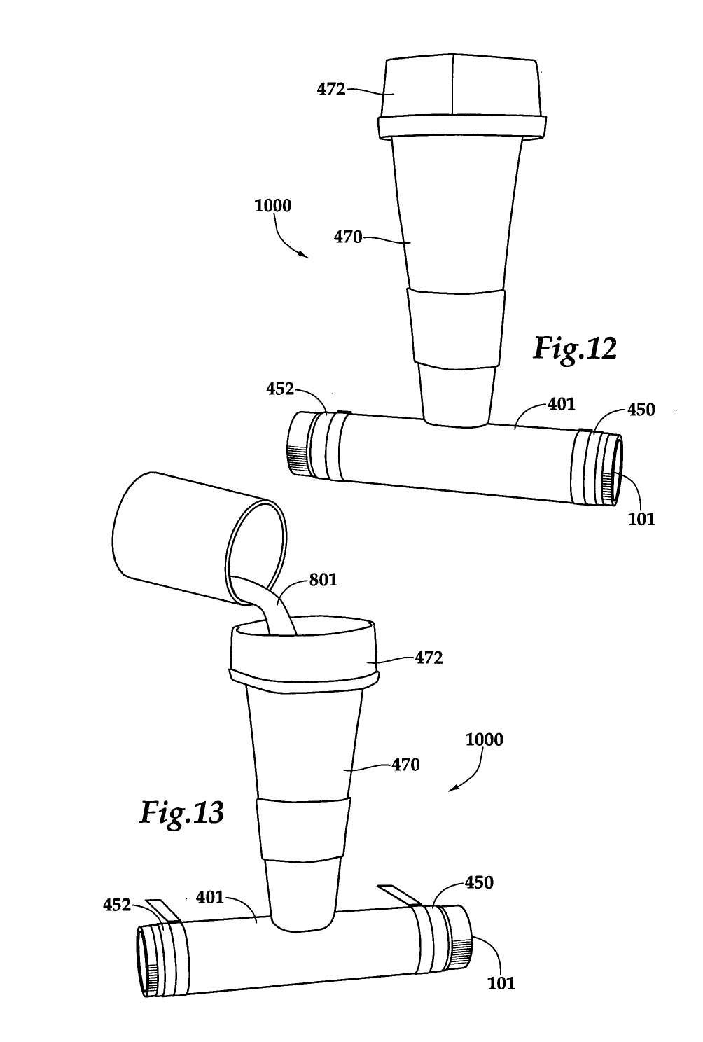

FIG. 12 is a perspective view illustrating an upper portion 472 of an integral funnel 470 of the pipe sleeve 401. The upper portion 472 may be turned down in preparation of pouring resin 801 into the pipe sleeve 401.

When the pipe sleeve 401 is properly secured and sealed to the pipe 101 in step 80 (FIG. 1) a polymeric resin is poured or pumped into the funnel 470. Sufficient resin is used to fill the annulus between the exterior surface of the pipe 101 and the inside of the pipe sleeve and to fill the funnel 470 at least partially full. FIG. 13 is a perspective illustrating resin 401 being poured into the pipe sleeve 470 via the integral funnel 470. It is understood that resin may also be pumped into the sleeve via an injection port (not shown).

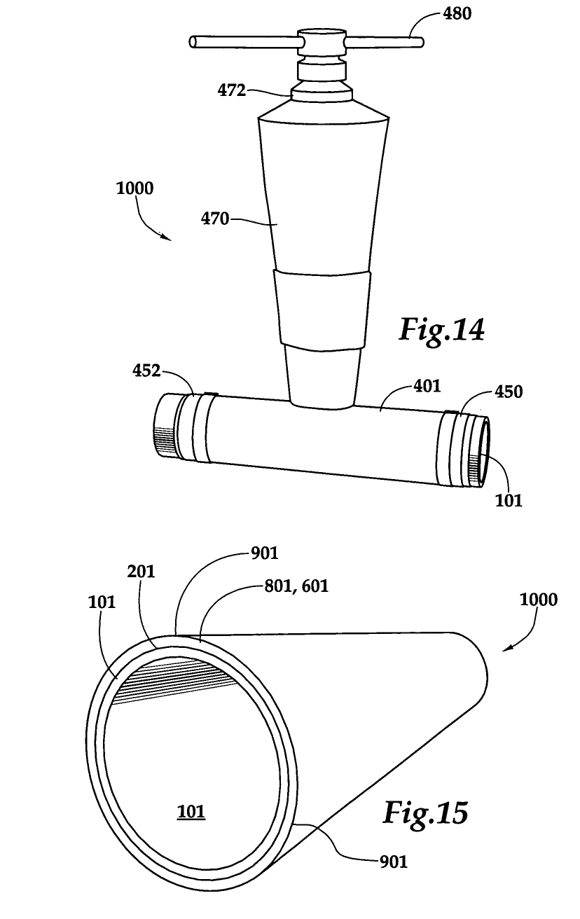

FIG. 14 is a perspective illustrating the upper end 472 of the integral funnel 470 of FIG. 12 turned up and having a bar 480 inserted in the upper section 472 of the funnel for twisting and thereby reducing the volume of the funnel which exerts pressure on the resin 801 contained in the integral funnel and sleeve 401 of FIG. 12. The bar 480 may be manually turned and thereby twisting and compressing funnel 470. The resin 601 is extruded from the funnel into the annulus between the pipe sleeve 401 and pipe 101 and forces the resin into the fiber wrap 601.

It has been determined that without the imposition of external pressure it may take 8 to 12 hours for the polymeric materials to penetrate the reinforcing structure 601. Maintaining a polymeric material 601 in a fluidic condition sufficient to penetrate the wrapped reinforcing structure for such an extended period is difficult and is directly related to the pot life of the resin. Additionally, waiting such an extended period for the polymeric material to penetrate the reinforcing structure delays completion of the repair and may result in costs and time delays. Therefore, it is very advantageous to accelerate the penetration rate of the polymeric material into the wrapped reinforcing structure. This can be done by applying external pressure to the pipe sleeve 401 and the polymeric resin 801 contained in the containment component.

It will be understood that, in alternative embodiments, instead of using a funnel 470, the resin 601 may be poured or pumped inside pipe sleeve 401 through openings, injection ports or fill tubes. For example, a polymeric material/resin 601 may be poured into an opening while air and resin gases (potentially hazardous or noxious fumes) in the annulus between the pipe 101 and pipe sleeve 401 are diverted through a second opening and a vent line to a sufficient distance from the installer. It will be understood that if the resin gases (fumes) are particularly noxious, they may be collected and vented or disposed of at a location remote from the installer. Alternatively, a single opening in the pipe sleeve instead of two openings, or more than two openings in the pipe sleeve may be utilized to add resin 601. Furthermore, sealable openings at other portions of the repair system 1000, such as at the end portions 450 and 452, may be used to add resin 601 inside the pipe sleeve 401.

In an alternative implementation, the openings may comprise fittings or other connectors configured to receive tubes that facilitate the filling of resin 601 and/or the displacement of air and fumes. Additional pressure may be applied, such as with an external pumping mechanism (not shown), or by pushing or squeezing the flexible pipeline sleeve formed from fabric, plastic, etc. against the resin. The sleeve may also contain one or more fittings or connectors to which a gauge may be attached in order to monitor the pressure while the resin is filling the sleeve 401 and impregnating the fabric wrap 601 and while the resins is curing. Monitoring of the pressure during curing can assist in determining when the resin has cured significantly to allow removal of external pressure on the pipe sleeve 401 and/or when the pipeline operating pressure may be returned to normal or elevated.

It should be emphasized that the terms “resin” or “polymeric material” are used herein interchangeably and as used herein is intended to broadly cover a variety of polymers, prepolymers, resins, hardeners, plastics, compounded mixtures, and so forth. Polymeric material of this type may be obtained from the Philadelphia Resin division of ITW.

Properties of the cured composite to be considered may include shear strength, glass transition temperature, and the coefficient of thermal expansion, and so on. Exemplary polymeric materials applied to the reinforcing material (e.g., dry fiber structure 601) may include thermosets or resins, such as phenolic resins, epoxy resins, polyurethanes, amino resins, Nylon, polycarbonates, and so on. Exemplary thermoplastics that may be utilized include polyethylene, polypropylene, polyvinyl chloride, polystyrene, and other thermoplastics. Further, it should be noted that the polymeric material or resin 801 applied to the fiber structure 601 may initially be a short chain prepolymer molecule.

Chemical cross-linking generally starts as the epoxy resin and non-latent curing agents are mixed. Curing agents may be slow to react with epoxies, such as aromatic amines or anhydrides, and may maintain low viscosity in larger masses or if heated. As mentioned, processing temperatures may play a significant role in determining the properties of the final composite. Moreover, the times and temperatures employed may depend on the curing agent selection.

The viscosity of the formulation should be low enough to substantially penetrate the reinforcing fibers 601. Mixtures of epoxy resin and curing agents having relatively higher viscosities may be heated to lower the formulation viscosity. However, heating may reduce the working time by accelerating the reaction depending on the type of curing agent.

In some implementations, external heat may be applied via heat wrapping of the outer pipe sleeve 401. This heat wrapping may be especially desirable in low temperature installation conditions. The heat wrapping may include resistive electrical heating, chemical reaction type heat packs or hot air/gas blown onto the exterior or into the interior of the pipe sleeve 401.

Ultimately, the resin 601 cures to form a composite or matrix of the resin and fiber to repair the anomaly, advance the integrity of the piping system, and/or to restore operating pressure capability of the piping system.

FIG. 15 is a perspective end view of a section of pipe repaired having a composite system 1000 repair in accordance with one implementation of the present invention. The exemplary layers of the pipe repair system 1000 include the pipe 101 and primer/adhesive 201. Upon completion of the pipe repair system 1000, the initially dry fiber wrap 601 disposed on the pipe 101 is substantially saturated with the now cured resin 801. Together, the resin 801 and fiber structure 601 form a matrix or composite 901 on the pipe 101.

The containment component 401 may remain installed or be removed, depending on the particular application. However, the containment component 401 is not designed to carry any significant portion of the pipeline stress load. Finally, as appreciated by those of ordinary skill in the art, the completed repair system 1000 may be subjected to a variety of testing to determine the in-service integrity of the pipeline system and the estimated lifetime of the repair system 1000.

Additionally, it will be appreciated that in certain implementations, it might be useful to be able to at a later date identify where a repair was conducted on a piping system. Various methods of identification might be used. Magnetic powder could be included in the resin or a magnet might be included during the fiber wrapping step. A magnetic detecting device would detect the magnetic field and identify the repair site. Additionally, an intelligent chip device might be included during the wrapping step or the resin filling step and such device could be identified in the future.

A number of embodiments of the invention have been illustrated in the accompanying drawings and described in the Detailed Description. It will be understood that the invention is not limited to the embodiments and implementations disclosed, but is capable of numerous modifications without departing from the scope of the invention as claimed.

What is claimed is:

1. A method of reinforcing a portion of pipe having a defect comprising:
applying a fiber structure to a portion of pipe to be reinforced;
installing a sleeve enclosing the portion of pipe to be reinforced and at least a portion of the fiber structure;
disposing a polymeric material between the sleeve and the fiber structure enclosed in the containment element to substantially saturate the fiber structure; and
permitting the polymeric material to cure to form a composite of the fiber structure and the polymeric material on the surface of the portion of pipe to be reinforced.

2. The method as recited in claim 1, wherein the portion of pipe having a defect includes at least one member selected from the group of Y's, elbows, Tees, crosses and nozzles.

3. The method as recited in claim 1, comprising substantially sealing the sleeve to the pipe having the defect.

4. The method as recited in claim 3, wherein the sleeve element comprises a fabric sleeve, and wherein placing the polymeric material comprises pouring the polymeric material inside the sleeve through at least one opening disposed on the sleeve.

5. The method of claim 3 wherein the fabric sleeve has a fabric funnel connected to the at least one opening disposed on the sleeve.

6. The method of claim 5 further including the steps
(a) closing the top of the funnel;
(b) attaching a bar to the upper portion of the funnel;
(c) twisting the bar to reduce the volume of the funnel and exert pressure on the resin contained in the funnel and fabric sleeve thereby forcing the resin to penetrate at least a portion of the fabric.

7. The method as recited in claim 1, wherein applying the fiber structure comprises wrapping the fiber structure around an outer surface of the pipe section to be reinforced.

8. The method of claim 7 wherein the fiber structure is spirally wrapped with partially overlapping layers around the outer surface of the pipe section to be repaired.

9. The method as recited in claim 1, wherein the fiber structure is not impregnated with polymeric material prior to or while applying the fiber structure to the object.

10. The method recited in claim 3 further including temporarily connecting an injection port disposed in the sleeve to a source of pressurized polymeric material; and
injecting polymeric material under pressure through the injection port into the container element.

11. The method of claim 1 further comprising:
temporarily connecting an external source of pressurized material to an injection port assembly disposed on the sleeve;
temporarily opening an evacuation port assembly disposed on the sleeve;
substantially filling the annulus with pressurized material from the external source and pressurizing the annulus to a predetermined pressure;
sealing the injection and evacuation ports assemblies after the annular space is filled and pressurized.

12. A method of repairing a pipeline, comprising:
applying a woven dry fiber structure around a defect on a segment of the pipeline;
installing a fabric sleeve around the segment of the pipeline having the anomaly and the dry fiber structure, said sleeve forming a cavity between the sleeve and the pipeline and the dry fiber structure, said cavity capable of pressurization for an external source;
pouring a liquid resin inside the sleeve to substantially saturate the dry fiber material;
applying an external pressure through at least one opening in the cavity allowing the liquid resin to cure to form a repair composite over the anomaly on the segment of the pipeline.

13. The method of claim 12, wherein allowing the liquid resin to cure forms a reinforced polymeric composite.

14. The method as recited in claim 12, wherein applying the dry fiber structure comprises wrapping a dry fiber tape over the anomaly on the segment of the pipeline.

15. A system for repairing a pipe, comprising:
a dry fiber fabric configured to wrap around the pipe and to receive a resin after installation of the dry fiber on the pipe;
a sleeve configured to encase a portion of the pipe having the dry fiber fabric; and
a fluid resin formulated to be poured inside the container to penetrate the dry fiber fabric and to form a composite with the penetrated dry fiber fabric on the portion of the pipe.

16. The system as recited in claim 15, wherein the pot life of the fluid resin is in the range of 30 minutes to 90 minutes.

17. The system as recited in claim 15 comprising sealing elements configured to substantially seal the sleeve with the pipe and dry fiber, wherein a cavity is formed between the sleeve and pipe to receive the fluid resin.

18. The method as recited in claim 17, wherein the sealing elements comprise a flexible component.

19. The system as recited in claim 15, wherein the fluid resin comprises an epoxy system.

20. The system of claim 15 wherein the sleeve is a fabric sleeve.

21. A pipeline repair system of claim 15 further comprising:
an injection port assembly disposed on the sleeve, said injection port assembly having an access opening through the containment element, said injection port assembly being adapted for temporary connection to an external source of pressurized material and a first closure member adapted to maintain said pressurized material in said annular space;
an evacuation port assembly disposed on the sleeve, said evacuation port assembly having an access opening through the sleeve and a second closure member adapted to maintain said pressurized material in said annular space.

22. A pipeline repair system of claim 15 further comprising a fabric funnel attached to an opening in the sleeve.

23. The pipeline repair system of claim 22 further comprising a twisting device adapted to be inserted into an upper portion of the fabric funnel.
